(19) United States
(12) Patent Application Publication
(10) Pub. No.: US 2008/0046347 A1
(43) Pub. Date: Feb. 21, 2008

(54) Systems and Methods for Financial Reimbursement

(76) Inventors: Steven B. Smith, Holladay, UT (US); Nicholas A. Thomas, Orem, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/460,623

(22) Filed: Jul. 27, 2006

(51) Int. Cl. G07F 19/00

(52) U.S. Cl. 705/30

(57) ABSTRACT

The present invention relates to a financial software module or process for tracking, allocating, documenting, and facilitating the reimbursement of expenses. The module or process includes budgeting, incurring, recording, and tracking expenses, allocating expenses for reimbursement, documenting expenses, and facilitating the reimbursement of the expenses.

The initial receipt of expenses may occur automatically or manually, and expenses are tracked more easily as the expenses may be entered and tracking may begin as soon as the expenses are incurred. Documentation of received and tracked expenses may be provided and linked to the tracked expenses. Because expenses may be tracked and documented immediately upon incurring the expenses, the reimbursement of the expenses is facilitated and accelerated. The module or process works equally well with cash expenditures, and allows for the continual monitoring of budgets from multiple accounts to prevent unknowing overspending beyond budgeted amounts.

### BACKGROUND

1. Field of the Invention

The present invention relates to systems and methods for financial reimbursement. More particularly, the present invention relates to an efficient process for documenting, allocating, and reimbursing expenses between multiple clients with a software system.

2. Background of the Invention and Related Art

The present invention relates generally to computer-based money management systems for users and, more particularly, to the management of financial resources through the tracking and allocation of resources between defined actual and virtual accounts in an automated, computer-based system.

Financial accounting is well known to those skilled in the art. Accountants have been used by individuals and businesses to manage financial resources over the years. The development of the personal computer for every day use has allowed the simplification of personal and business accounting by a user. Such financial accounting programs include QUICKEN® by INTUIT, of Menlo Park, Calif., and MONEY® by Microsoft, of Redmond, Wash. These programs are well known and provide the every day user with simple yet robust accounting means for tracking one's financial resources.

For example, financial accounting programs offer account management services for managing one's checking account, savings account, and money market funds. These services also provide a user the ability to perform on-line banking services with their respective financial institution. Thus, utilizing these programs, a user can provide bill paying options and account recordation of transactions performed by the bank without having to receive an end-of-month financial statement from the financial institution. This allows the user to keep an up-to-date record of his or her financial transactions. These transactions can include checks written, credit card bills paid, deposits to retirement accounts, automatic bill payment options, and the like.

These programs also provide a rudimentary budgeting system that allows a user to see where his or her money is invested or spent. A user can establish a budget, which may be followed for financial discipline; however, the resources used to cover the budget typically are drawn from a single source or a few sources of revenue. An end-of-period, such as week, month, quarter, or year, statement is provided for how the revenue had been allocated for different groups of financial interests to generate a budget allocation after funds have been drawn from but one or two sources. Thus, a user can establish a budget to follow, but the discipline of having a budget is not felt until a reconciliation of funds distributed during a given period is made with an accurate accounting of payment and distribution is done.

This delay in reconciliation of the budgeted and spent amounts can lead to several problems. For example, a user spending money on a trip can easily spend more than the budgeted amount without recognizing that the budget has been exceeded. The delay in reconciliation of funds until the end of the given period leads to an increase in the likelihood of problematic cases of overspending.

This problem is only exacerbated in the case of business travelers, many of whom often travel for multiple clients at the same time and have to distribute and allocate expenses between the clients. This is especially true when the business traveler has to report expenditures to a supervisor for approval of reimbursement from various client spending accounts. The current financial software solutions are ill-equipped to handle this problem. Even if such a business traveler is aware of the various budgets allotted for different clients before beginning an extended business trip, the traveler may quickly lose track of what has been spent on each account with the result of improper expenditures and the resulting lengthy explanations that may be required when later seeking reimbursement for expenditures for which documentation has been misplaced or for which a business traveler's memory is hazy.

Furthermore, the longer or more involved the business trip, the more easily the business traveler may lose track of the purposes behind expenditures or to which client each expenditure should be allocated. The loss of key receipts of expenditures only worsens the problem. Even where only a single client is concerned per trip, the loss of a key receipt or of the documentation of expenditures can result in loss of reimbursement for the business traveler or loss of the traveler's credibility with the client. The fact that allocating expenditures to the various clients usually occurs infrequently at best, or at worst some time after the termination of a particular business trip, errors of memory may also prevent proper allocation of expenditures for reimbursement.

The current financial software available is limited to financial recordkeeping, purchase analysis, and budget allocation. They do not have the ability to selectively track, allocate, and reimburse or pay for expenses from one or more funding sources. For example, an individual may be able to analyze how much they spend on food for a given period of time but is not able to readily determine that certain food expenditures belong to certain clients, and it is difficult to keep budgets current with expenditures on an ongoing basis. The software may also assist in encouraging the individual to stay within a specific food budget. Likewise, the software could be used by a corporation to track spending on office equipment and assist in determining whether to make additional purchases. However, it is not possible to utilize existing financial software packages to integrate personal spending for business purposes such that a business can efficiently reimburse the expense to the individual from multiple client accounts.

Accordingly, there is a need for a software module or process for tracking, recording, allocating, and documenting expenses and for facilitating the reimbursement of business expenses. There is also a need for a software module or process that can be incorporated into a financial package for facilitating these goals.

### SUMMARY OF THE INVENTION

The present invention relates to a financial software module or process for reimbursement of expenses. The module or process includes tracking and recording expenses, allocating expenses for reimbursement, documenting expenses and facilitating the reimbursement of the expenses.

The initial receipt of expenses may occur automatically, such as by monitoring credit card and bank transactions. However, the person who incurs expenses also enters expenses manually so as to identify accounts to which the expenses should be allocated. The expenses are tracked more easily as the expenses may be entered and tracking may begin as soon as the expenses are incurred. Providing documentation of received and tracked expenses may occur immediately upon incurring the expense, or may be delayed for a period of time and provided later. Because expenses are tracked immediately upon incurring the expenses, the reimbursement of the expenses is facilitated and dependent only upon receipt of proper documentation and potentially upon approval by a supervisor or manager, and the documentation may also be provided simultaneously. The module or process works equally well with cash expenditures, and allows for the continual monitoring of budgets from multiple accounts to prevent unknowing overspending beyond budgeted amounts.

The reimbursement of the expense is facilitated by communicating with the particular reimbursement organization. For example, an expense which is allocated as a business expense will be communicated to the business in which the expense will be reimbursed. This communication may involve interfacing with a financial module or generating a reimbursement request. While embodiments of the present invention are directed at a financial software module or process for reimbursement of expenses, it will be appreciated that the teachings of the present invention are applicable to other areas.

Additional embodiments of the present invention relate to integration of the reimbursement process with existing financial software. Therefore, users would have the ability to allocate incoming funds to either conventional budget categories or reimbursement categories. These existing financial software packages would include MONEY® and QUICKEN® financial software packages which are commonly used to track expenses from a single entity.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a suitable operating environment for the present invention;

FIG. 2 illustrates one embodiment of the present invention of a method for reimbursing financial expenses;

FIG. 3 illustrates an embodiment of the present invention as implemented in a graphical user interface on a computer device;

FIG. 4 illustrates another view of an embodiment of the present invention as implemented in a graphical user interface on a computer device; and

FIG. 5 illustrates an alternative embodiment of the present invention in which a method for reimbursing financial expenses is integrated with a conventional financial software module for a user with personal and business expenses.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to a financial software module or process for tracking, allocating, documenting, and facilitating the reimbursement of expenses. The module or process includes incurring, recording, and tracking expenses, allocating expenses for reimbursement, documenting expenses, and facilitating the reimbursement of the expenses.

The initial receipt of expenses may occur automatically, such as by monitoring credit card and bank transactions. However, the person who incurs expenses also enters expenses manually so as to identify accounts to which the expenses should be allocated. The expenses are tracked more easily as the expenses are entered and tracking begins as soon as the expenses are incurred. Providing documentation of received and tracked expenses may occur immediately upon incurring the expense, or may be delayed for a period of time and provided later. Because expenses are tracked immediately upon incurring the expenses, the reimbursement of the expenses is facilitated and dependent only upon receipt of proper documentation and potentially upon approval by a supervisor or manager. Additionally, the documentation of expenses may also occur immediately, further increasing the rapidity with which expenses may be reimbursed. The module or process works equally well with cash expenditures, and allows for the continual monitoring of budgets from multiple accounts to prevent unknowing overspending beyond budgeted amounts.

The reimbursement of the expense is facilitated by communicating with the particular reimbursement organization. For example, an expense which is allocated as a business expense will be communicated to the business in which the expense will be reimbursed. This communication may involve interfacing with a financial module or generating a reimbursement request. While embodiments of the present invention are directed at a financial software module or process for reimbursement of expenses, it will be appreciated that the teachings of the present invention are applicable to other areas.

As used in this specification, the following terms are defined accordingly:

“expenses”—are financial events which involve the debiting or crediting of a valuable commodity. For example, purchasing groceries on a credit card is an expense which involves money.

“financial resources”—financial institutions or systems which facilitate the transaction of expenses. For example, a bank is a financial resource because it facilitates the expenditure of money through checks and/or cash withdrawals.

“user input device”—a device in which a user can input data into a computer or other electronic device. For example, a scanner could be used to scan a receipt into a digital format. The scanner could be a handheld business-card type scanner.

“reimbursement identifier”—a variable which identifies an expense as requiring reimbursement. In order to facilitate the integration of the reimbursement process with an existing accounting module, it may be necessary to utilize predefined reimbursement identifiers.

“reimbursement request”—a communication directed for the purpose of initiating a reimbursement process. For example, a reimbursement request could be data transmission to a computer or an email to an individual.

“virtual financial account”—is a financial account designated for a particular purpose but not corresponding in a one-to-one relationship to an actual financial account. For example, a virtual financial account could be generated for home repairs. A virtual financial account could include both a direct transaction expense and a reimbursable expense.

“direct transaction”—is a type of expense in which the purchaser is personally financially responsible for payment. For example, an individual is generally personally financially responsible for fixing their car.

“reimbursable transaction”—is a type of expense in which another entity is responsible for reimbursing the payor/purchaser. For example, a business lunch is an expense which is generally reimbursable by an employer because the purpose of the lunch relates to the user's employment.

The following disclosure of the present invention is grouped into two subheadings, namely “Exemplary Operating Environment” and “Financial Tracking and Reimbursement”. The utilization of the subheadings is for convenience of the reader only and is not to be construed as limiting in any sense.

### Exemplary Operating Environment

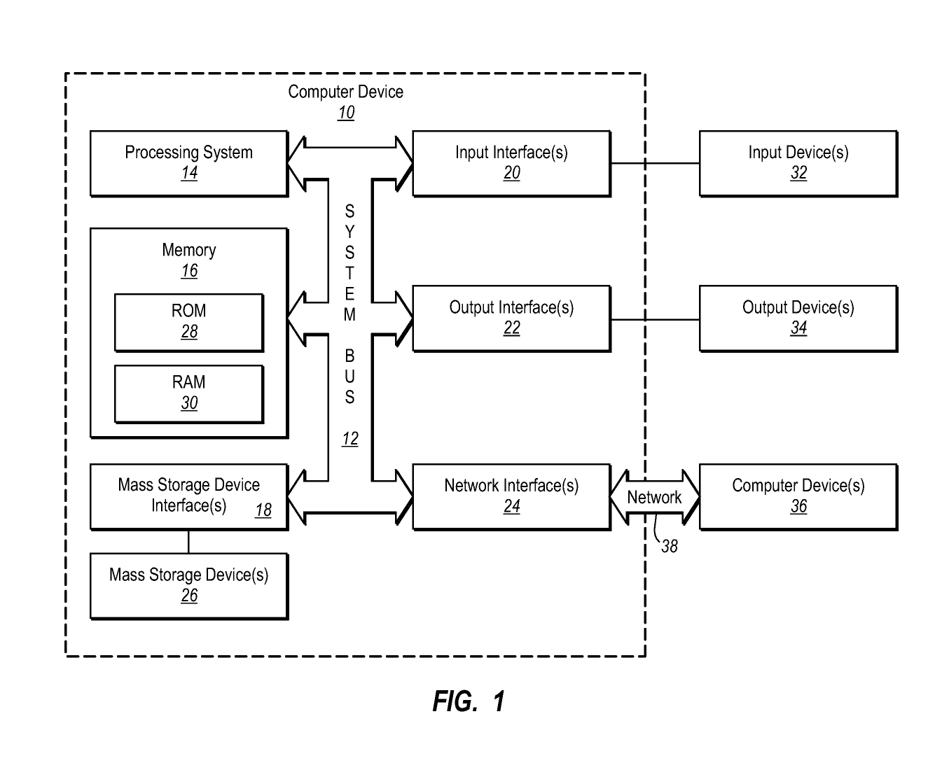

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a laptop or notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Financial Tracking and Reimbursement

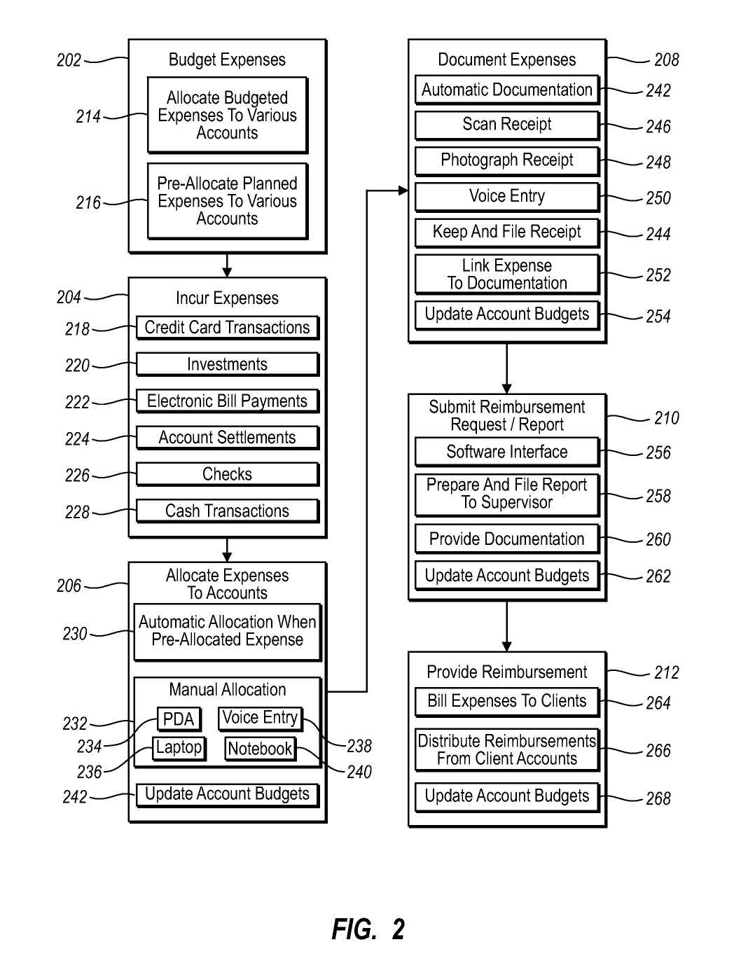

Reference is next made to FIG. 2, which illustrates one embodiment of the present invention of a method for tracking and reimbursing financial expenses. The method generally involves the steps of budgeting expenses 202, incurring expenses 204, allocating expenses 206, documenting expenses 208, submitting reimbursement requests or reports 210, and providing reimbursements 212. These acts may be performed manually or automatically as described below. Furthermore, various software architectures could be utilized in the execution of the method such that it is performed efficiently and is capable of performance in a wide variety of situations.

As illustrated in FIG. 2, the method optionally begins with the step of budgeting expenses 202. For example, a business traveler preparing for an extended business trip that will involve serving the needs of several clients might determine the amount of money to be spent on the trip and then might allocate budgeted expenses to various accounts at step 214. Similarly, a business traveler intending to spend some portion of a business trip in pleasurable rather than business activities, might budget some expenses to client accounts and some expenses to a personal account at step 214. In another example, a business with several employees might budget the efforts of different employees to different accounts at step 214.

In any such situation, the business traveler or business may be aware of pre-planned expenses, such as hotel reservations, car rentals, or conference dues. Such expenses where the amount or location of such expenses may be pre-allocated to various accounts at step 216, and such pre-allocated amounts may be entered into the budget as pending transactions to keep the budget at its most updated level. One example of pre-allocation of expenses is where a business traveler visits one location on behalf of several clients, and the hotel bill is divided among those clients. A similar example is where several traveling employees working on behalf of different clients share expected expenses such as car rental or hotel room, and planned expenses are to be divided between employees or clients.

The step of budgeting expenses may optionally be omitted, either due to poor planning or necessities of time. Occasionally, a traveler simply knows how much money is available in an account, and rather than planning a budget, simply engages on a trip with the expectation of spending less than is available in the account. The present method is particularly helpful for such individuals. Inevitably, whether budgeting has occurred or not, expenses are incurred at step 204 that must be paid from some account, either a personal account or through reimbursement. The present method provides means for facilitating tracking, budgeting, and reimbursement of expenses incurred at step 204 whether originally budgeted or not. The method does so in a manner that is efficient, capable of continual updating, and less prone to error or eventual loss of data or reimbursement.

Expenses may be incurred through a variety of methods, some of which are illustrated at step 204. Some expenses are more easily tracked and allocated than others, but the present method provides for tracking and allocation of all expenses. Some example expenses or methods of incurring expenses include credit card transactions 218, investments, 220, electronic bill payments 222, account settlements 224, checks 226, and cash transactions 228. Although not illustrated, various other methods and systems for incurring expenses are contemplated and consistent with the present invention. One problem with past methods of budgeting and tracking of expenses is the inability to deal with this broad range of methods of incurring expenses. The current method allows simple tracking and allocation of incurred expenses to provide updated budgeting to the point of real-time budgeting, and to provide facilitation of expense reimbursement.

The method achieves these goals in part through allocation step 206. In this step, allocation of expenses to assigned accounts is performed. The allocation may occur automatically through some sort of predefined rule at step 230 or manually at step 232, potentially using various user input devices, depending on the nature of the expense incurred. For example, if the expense is a planned expense budgeted in steps 202 and 216, the standard methods of payment for such expenses may be monitored to discover the occurrence of the expenses and to provide automatic allocation of the expense. In one example, a hotel reservation made for a certain hotel at a fixed amount may have been budgeted at steps 202 and 216. Upon staying at the hotel, the business traveler will incur the expenses for the reservation, and pays the expense by check, credit card, debit card, or similar means at step 204. A monitoring service or computer program linked to a credit card account or bank account is able to note the occurrence of the charge and the location of the charge, and attempts to match the incurred expense with the budgeted and pre-allocated expense. If a match is found, the service or program may automatically allocate that expense to the assigned account.

Similarly, a business traveler may incur expenses for one client in one city and expenses for another client in another city. In this situation, the service or program may automatically allocate all expenses incurred in one city to one assigned account and all expenses incurred in another city to another assigned account. In another example, an individual may utilize a separate credit card for certain business expenses or for expenses for a particular client. Various other automatic allocation systems may be utilized and remain consistent with the present invention. In any one of the preceding situations, the automatic allocation may be tentative and a confirmation message sent to the traveler to allow the traveler to review the automatic allocation and confirm or reassign the automatic allocation.

Most commonly, however, expenses will not be automatically allocated to the proper account. The present method embraces that situation. Upon or after incurring the expense at step 204, the user manually allocates the expense at step 232. This manual allocation may occur through the use of any number of allocation means, such as those represented in FIG. 2. The user may enter the expense through a program on a PDA 234 or laptop 236, may make a reference allocating the expense through a voice entry 238 on a voice recorder, laptop, or other voice-capable system, or may simply enter and allocate the expense in an expense log such as a pen-and-paper notebook 240 for later entry into an electronic system or reimbursement request. For any method of allocation of the expense, the allocation may be communicated to an administrator, another location, or a central repository such as through electronic mail.

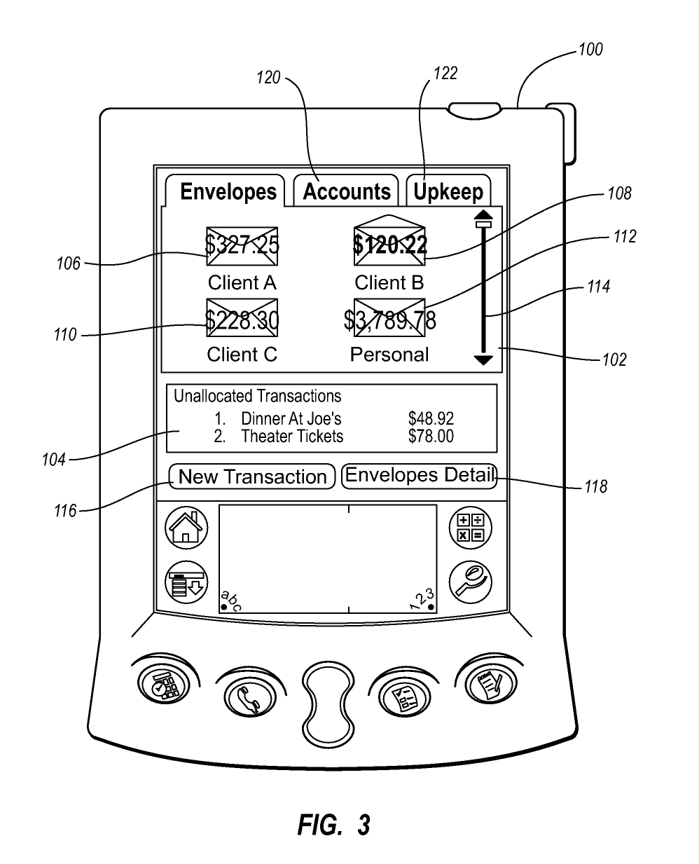

FIG. 3 illustrates a program implementation of a method of allocating expenses on a PDA 100. In FIG. 3, the PDA is shown displaying information related to allocation of expenses to various accounts. The display is divided vertically into two regions, an account display 102 and an unallocated transaction display 104. Within the account display 102 are located several envelopes 106, 108, 110, and 112 corresponding to various accounts. Envelope 106 corresponds to the account for Client A, envelope 108 to the account for Client B, envelope 110 to the account for Client C, and envelope 112 to the user's personal account. As can be readily appreciated, a large number of accounts may be accessed through scroll bar 114. Shown in unallocated transaction display 104 are two transactions. If further unassigned transactions were to be displayed, they could be accessed through a scroll bar similar to scroll bar 114.

In use, the user or business traveler would enter a new transaction by selecting new transaction icon 116. Upon selection of this icon, a new display would be shown allowing the user to enter the details of the expense incurred at step 204. The transaction would then be added to the unallocated transaction display 104, unless the user allocated the new transaction to an envelope/account at the same time as entering the transaction. Alternatively, a new transaction could be automatically entered into the unallocated transaction display 104 through monitoring of credit card or banking accounts as discussed above. The user could then select the added transactions to add details to better document the nature and purpose of the transaction before allocating the transaction to the proper envelope/account.

Once an incurred expense has been entered into the program so as to be displayed in the unallocated transaction display 104, the user may allocate the expense according to step 232 by selecting the expense and selecting the envelope or account to which the expense belongs. This may be done, for example, by dragging the expense from the unallocated transaction display 104 to the appropriate envelope in account display 102. Ideally, upon allocation of the expense to the proper account, the account budget would be updated as at step 242 in FIG. 2. This would be reflected in the display of FIG. 3 by a change in the displayed account balance in the envelope corresponding to the assigned account/budget in the account display 102. This provides an advantage of displaying to the user an update of the available budget for each envelope or account nearly as soon as the expense has been incurred.

The account display 102 in FIG. 3 also shows additional tabs 120, 122 relating to further functionality of the program. This functionality may relate to other aspects of the financial software on the PDA 100, or it may relate to further subdivision of accounts and expense allocation. For example, tab 120 may show a different view for various accounts, and the envelopes 106-112 seen in FIG. 3 may be related to sub-budgets associated with a single client or account rather than individual clients/accounts. Thus it may be seen that the present method of budgeting and maintaining accounts is practically limitless in its application and functionality.

In many instances, mere recording and allocation of expenses incurred is not sufficient to allow proper reimbursement of the expenses incurred at step 204. Many clients or administrators desire to see documentation of incurred expenses to prevent attempted defrauding of the client by the business traveler. Thus the present method continues to the documenting of expenses at step 208 as seen in FIG. 2. As in the step of allocating expenses, the documenting of expenses may also occur manually or automatically. Automatic documentation 242 may occur in the case of pre-allocated expenses through the monitoring of bank or credit accounts and using the account record to provide the documentation. Manual documentation may occur through a number of various means depending on the size of the expense, the form of documentation acceptable to the client or the administrator, and whether a receipt was issued in conjunction with the incurring of the expense at step 204.

In some instances electronic receipts may be provided at the time of purchase, such as for transactions occurring on the Internet, and with certain types of other transactions that are now becoming available, such as via text-based cell phone payment networks, near-field communication devices, and other methods where electronic receipts are generated. In such instances, it is generally a simple matter to associate the already-electronic receipt with the transaction or expense.

If a paper receipt is generated, and the client or administrator requires the original receipt to provide reimbursement, the receipt may be kept and filed as in step 244. However, the advent of portable scanners and of cell phones and PDAs with the capability of taking pictures, the step of keeping the receipt for filing can now be done away with in most cases. For example, if the traveler has a portable scanner, the traveler may scan the receipt almost immediately upon receiving it at step 246 to eliminate the need to keep the receipt and eliminating problems with lost receipts. With the availability of compact multifunctional devices, the traveler could also take a picture of the receipt at step 248. In either case, the image of the receipt could then be stored in a file in an electronic device to electronically document the incurred expense.

Some expenses do not always generate receipts, such as small incurred expenses like tips, public transportation fares, or other sundry expenses. Often, in these cases, reimbursement depends on the willingness of the client or administrator to believe that the expenses were incurred as claimed. The present method provides for improved documenting of these expenses by allowing the traveler or user to record a voice entry 250 at the time of incurring the expense at step 204, and the proximity of the voice recording to the incurred expense provides assurance to the client or administrator that the expense was actually incurred. This also eliminates problems with faulty memory on the part of the traveler. A similar effort may be made by immediately entering in the expense as in the manual allocation step 232.

Electronic documentation of an expense provides a form of documentation that is less susceptible to loss than the methods of keeping paper receipts in a wallet, but the current method provides other advantages as well. Because both the record of the expense and the documentation of the expense may be stored in electronic format, they may be linked to each other to completely provide the necessary information for reimbursement at step 252, and this linking may occur at any time from immediately upon incurring the expense at step 204 to the point of submission of the expense for reimbursement.

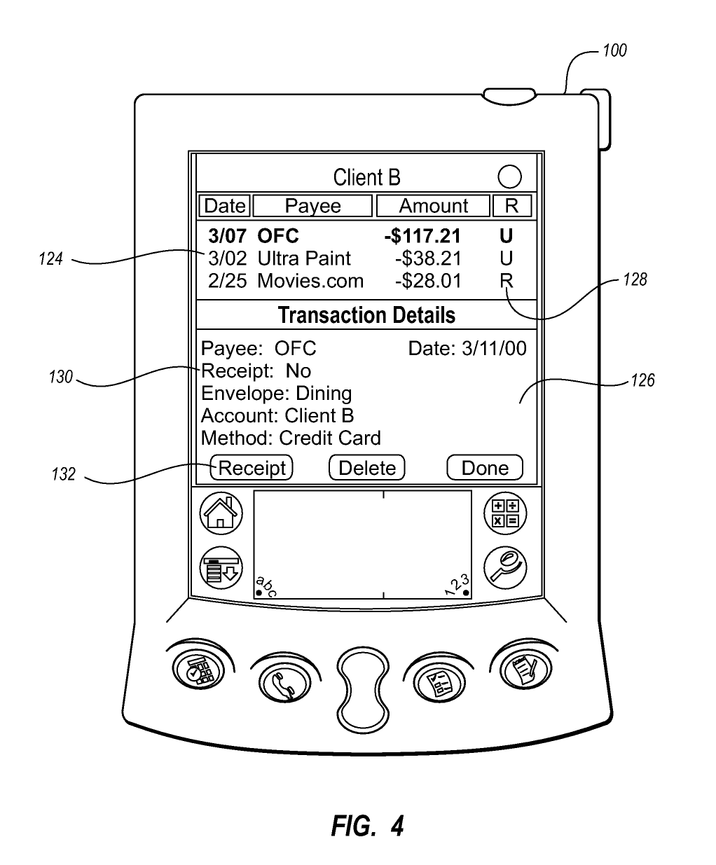

As an example, referring to FIG. 3, the Envelopes Detail icon 118 may be selected to view the details of the transactions assigned to a particular envelope/client. This would bring up a new display as depicted in FIG. 4. The display is divided again into a transaction summary display 124, and a transaction detail display 126. The transaction detail display 126 shows the details entered for a transaction selected in the transaction summary display 124. The transaction summary display shows whether an expense has had documentation provided in column 128 by showing whether a transaction has been receipted (“R”) or unreceipted (“U”). The transaction detail display shows the same information on line 130. The user may view or change a receipt associated with a transaction or associate an electronic receipt with a transaction by selecting receipt icon 132.

The program would then ask the user if the receipt is contained in an already-existing file or whether a new file should be captured. If an existing file is chosen, the program would prompt the user to browse and select the file, and would display the receipt to the user for confirmation. If capture is chosen, the program would prompt the user to scan, photograph, or record a voice notation as appropriate given the user's choice and available options. After a receipt is associated with a transaction, it may be viewed, printed, or transmitted to a central location, client, or supervisor, according to the desires of the user or traveler. Furthermore, account budgets optionally may be updated at step 254 upon entering of a receipt to reflect the documented nature of the incurred expenses and the remaining budget for a particular client or expense category.

Although the method has been displayed in FIGS. 3 and 4 as occurring in a program on a PDA 100 using a particular graphical user interface (GUI), it may be readily appreciated that the method may be implemented with other systems and other interfaces or displays. For example, the method might be implemented on a laptop or home computer. The method might also be implemented on a user-accessible website that would allow a user to access the program from any Internet-connected computer to record expenses, document expenses, or submit requests for reimbursement. While the envelope-based GUI shown in FIGS. 3-4 is easily understood, many other types of interfaces could serve equally well, including interfaces that are purely text based, for implementation on devices with lower memory or bandwidth, such as cell phones and smart phones. Thus the method is highly adaptable to accommodate the needs of business travelers in almost any situation.

Thus the present method provides for near real-time updating, tracking, and documenting of incurred expenses. Optionally, if real-time updating is not possible, the present invention also embraces some delay in the recordation, allocation, and documentation of incurred expenses, such as might occur by saving receipts and notes about expenses until the end of a day when a business traveler might then enter the information into a computer. Though not as advantageous, the present invention further embraces the situation where the user is unable to access a system to update, track, and document incurred expenses until a business trip has been completed. As can be readily appreciated, the benefits that can be provided as budgets are continually updated are reduced when the updating occurs only after an extended period of time. The method also embraces a situation where only one or two of the steps of recordation, allocation, and documentation of incurred expenses occurs temporally proximate the incurring of the expenses, and the step of updating the budget may occur based on the limited information at hand and provide the benefit of budget tracking based on the limited information.

As may be appreciated, if reimbursement is to be provided for incurred expenses, the expenses must be submitted for reimbursement, as at step 210 in FIG. 2. Typically, this is done by submitting a reimbursement request and report to the client or a supervisor indicating the expenses, the reasons for the expenses, and any accompanying documentation. The request or report may be by e-mail, fax, letter, phone call, etc., and may be automatically or manually generated. The present method provides a number of methods for accomplishing this step. First, a software interface may be provided as part of the tracking software exemplarily displayed in FIGS. 3 and 4. An icon or option may be provided (not shown) that allows the user or business traveler to submit a transaction or group of transactions. The step of submitting is enhanced by the connectivity of today's computer and portable devices. Upon submission, the transaction listing or listings, the allocated clients and/or account detail envelopes, and any attached documentation files are transmitted to the client or supervisor. Optionally, the software interface 256 may automatically generate a summary report in conjunction with the reimbursement request submission for the convenience of the recipient.

As may be appreciated from this description, the software interface 256 allows not only near-real time recordation, updating, tracking, and documentation of incurred expenses, but also near-real time reporting and submission of reimbursement requests. For example, a business traveler with a camera-enabled PDA might go out to entertain clients with dinner. When the check comes for dinner, the traveler enters a new transaction into the program on the PDA, selects the proper client, account, and envelope detail to which the expense should be allocated, selects the receipt icon 132, snaps a picture of the signed receipt or check, and immediately submits the transaction for reimbursement. Before the business traveler stands to leave the dinner table, a fully-documented request for reimbursement has been submitted which potentially might be fulfilled well before the business traveler returns from the trip. As may be appreciated, the submission of the reimbursement request may also permit updating of account budgets at step 262 to show the fully-documented and submitted request. Or, in the case of account or budget tracking where an account allocation has been made but reimbursement will not occur, the submission acts as a report to fully track expected budget items and keep expenditures within budgetary guidelines.

In some cases, wireless communication of reimbursement requests or spending reports is not feasible, due to a non-connected device, a non-portable device, a lack of time, or a variety of other potential reasons. The method also embraces the delayed submission of reports and reimbursement requests, as also depicted in FIG. 2. For example, a traveler might wait and file a daily expense report from the comfort of a connected hotel or a trip expense report at the end of a business trip as in step 258. Such reporting might occur even if continual updating has occurred through a software interface 256 as described above. The report or reimbursement request with attached documentation (provided either as electronic copies or as attached hard copies in step 260) may be transmitted while on the go or submitted formally at the end of the business trip. In such a case, account budgets may be updated in step 262 as described above. As may be readily appreciated, the report may have divisions for various clients or budget categories, and may be submitted in various forms without departing from the spirit of the invention.

Finally, in cases where reimbursement will occur, i.e. when recording, tracking, updating, documenting, and reporting expenses occurs for reasons beyond controlling spending to keep it within predefined limits, the method also embraces the eventual reimbursement of the incurred expenses as in step 212. To achieve this, a bill may be sent to the client with a request for reimbursement as in step 264. The bill sent may be the report or reimbursement request generated in step 210 and may include the documentation generated in step 208. As clients pay the bills, the reimbursements may be distributed in step 266. Alternatively, a bill may not be sent to the client, but a supervisor may approve a reimbursement request and provide reimbursement from funds on hand in a client account, also in step 266. Finally, as funds are distributed and reimbursements received, final updating of account budgets occurs as in step 268 to reflect the expenditures and reimbursed expenses. As may be appreciated, the method provides for a means of achieving finality of budget updates much more quickly than has been possible before.

This method provides benefits for business travelers even where a business trip is dedicated to a single client. First, as described above, reimbursement may occur much more quickly than through previous methods. Second, even if a business account is available, say to pay by check, many people prefer to use personal credit cards and then seek reimbursement so as to receive the benefits of card reward programs. The present method eliminates many of the risks from such an approach such as eventually unreimbursable expenses due to lost receipts. Furthermore, as has been recounted, near-real-time updating of budgets may occur to allow the traveler to curb spending before disastrous overspending unwittingly occurs. Finally, eventual reporting and accounting is simplified since expenses may be entered and documented on the go without worrying about having to remember every detail at a later date.

The present inventive method is adaptable to a variety of other situations and circumstances. For example, an employer may utilize a particular accounting software module which tracks all financial transactions. A reimbursement could be facilitated by providing a software module to employees that simply sends an appropriately formatted communication to the software module such that the reimbursement is automatically processed by the software module. Various other methods and processes may be utilized for the facilitation of the reimbursement and remain consistent with the present invention.

As another example, a large company managing flexible health or child care spending accounts or cafeteria accounts may provide its employees with a software module that allows the employees to enter in transactions and documentation as expenses are incurred. This entering in and eventual submission may occur electronically as described, greatly reducing the need for intra-office mailings of copies of documents as well as the aforementioned loss of documentation that may occur in such a situation as easily as may occur on a business trip. The employees would easily be able to see the balance remaining and tentative balance remaining in their flexible spending account(s), even before final approval, and would be able to better plan expenses over the course of the account lifetime (generally annually). An added advantage is that when disputes occur as to the amount that should be in the account, the documentation as to expenses and allocated amounts is readily available in electronic format to settle the dispute.

Another advantage is provided to the average consumer. A consumer may have the desire to track budget from various spending categories just as a corporation or business traveler would. The current invention provides a method whereby continual tracking is easily achieved, and provides the added benefit of allowing the saving of important receipts in electronic format linked to the original transaction. Many times, consumers have a need for a receipt for warranty service or return, only to discover that a receipt was inadvertently discarded. Because the receipt may be stored indefinitely with the present method in electronic format, the consumer is not merely out of luck when this happens.

As may be appreciated, not every user will have the advantages provided by the technology described herein to be able to log and record, allocate, track, document, and submit expenses while on the go. The present method embraces users of various situations where these steps occur at a later time according to the user's available means and time.

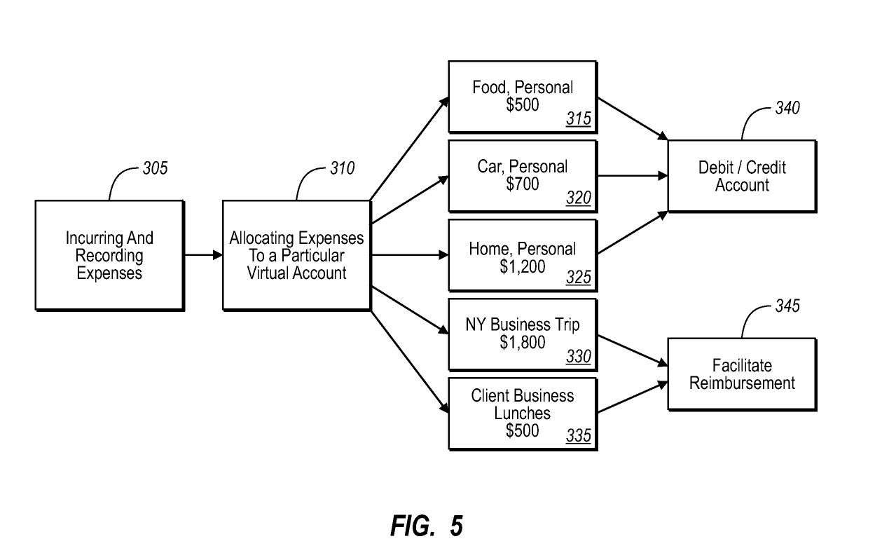

Reference is next made to FIG. 5, which illustrates an alternative embodiment of the present invention in which a method for reimbursing financial expenses is integrated with a conventional financial software module to assist in mixed-use financial tracking and budgeting for a user with personal and business expenses. Conventional software modules allow individuals to track their spending and create budgets for future spending. These provide useful tools for long range planning and day-to-day financial decisions. One type of financial software module involves creating virtual financial accounts which are designed to track expenses of a particular type. For example, a virtual financial account may be created for personal food expenses. These virtual financial accounts are designed to interface with a particular financial resource such as a bank account. The envelopes 106, 108, 110, 112 depicted in FIG. 3 may represent such virtual accounts or may also represent actual accounts.

The integrated reimbursement method includes incurring and recording expenses 305. The incurring of expenses may be accomplished in a variety of ways as discussed with reference to FIG. 2. Although not illustrated, any type of expense receiving system may be used and remain consistent with the present invention. These systems include both automatic and manual expense receiving systems.

The incurred and recorded expenses are then allocated to a particular account, act 310. The allocation of expenses involves determining the nature of the expense and whether it would qualify for reimbursement. For example, a lunch may be properly allocated into the food, personal account 315 and subtracted from the monthly total of $500. However, if the lunch occurred on a business trip to New York, the expense may qualify for reimbursement and be properly allocated to account 330. Similar to the process described in reference to FIG. 2, the allocation can be manual or automatic depending on the specific implementation. Most financial software modules utilize a graphical user interface (GUI) to allow users to allocate expenses.

The various financial accounts include personal/direct transaction accounts 315, 320, 325 and reimbursable accounts 330, 335. Although not illustrated, an infinite number of accounts for any purpose may be created and utilized in conjunction with the described process. The personal accounts 315, 320, 325 are each designated for a unique purpose and given a budget such that a user can track expenses in each category and make decisions about whether to charge additional expenses. The reimbursable accounts 330, 335 are designated for a purpose that qualifies for some form of reimbursement, and may optionally also have assigned budgets. The reimbursement may relate to expenses that an employer would reimburse or some other form of reimbursable expense. For example, one of the illustrated reimbursable accounts relates to client lunches in which an employer will reimburse.

These reimbursable accounts are established by an individual or corporate user corresponding to the particular expenses which he/she knows are reimbursable. In addition, a catch-all or “other” account may be established such that a user could allocate expenses which do not fall within one of the existing accounts. The reimbursable accounts may further include a total value to indicate the amount of reimbursable expenses charged to a particular account. This value may be useful for circumstances in which reimbursable expenses of a particular type/account must be kept within a certain budget. Likewise, the reimbursable accounts may include a “reimbursed” and a “to be reimbursed” value which allows users to know how much of the expenses charged in a particular area have been reimbursed and how much are pending.

Although not shown, the step of documenting expenses 208 from FIG. 2 may occur as described above to facilitate budgeting, tracking, and requesting reimbursement of expenses incurred at step 305. Expenses which are allocated to the direct transaction accounts 315, 320, 325 are then virtually debited or credited, act 340, to reflect a dynamic budget account of the current expenditures in that area. This debiting and crediting is generally performed automatically utilizing a standard mathematical routine. For example, if a $500 car repair is performed and allocated to the direct transaction account 320, the account will be debited to reflect a remaining balance of $200. A user may then use this information to determine whether to purchase a $300 car stereo which would exceed the account budget. The expenses will also be tracked in each account such that a user could analyze the expenses over a period of time. When transactions clear in actual accounts, further updating may occur to reflect current budgeting situations.

Expenses which are allocated to one of the reimbursable accounts 330, 335 are then processed for reimbursement, act 345. As described in reference to FIG. 2, various techniques may be used to facilitate the reimbursement of allocated reimbursable expenses. These techniques include sending a reimbursement request and interfacing with an existing software module, as described above.

Thus, as discussed herein, the embodiments of the present invention relate to a financial software module or process for tracking, allocating, documenting, and facilitating reimbursement of expenses. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. An efficient computer-assisted method for reimbursement of expenses comprising the steps of:
providing a computer system capable of tracking accounts, incurred expenses and documentation for the incurred expenses;
incurring an expense;
recording the incurred expense on the computer system;
allocating the incurred expense to an account corresponding to a reimbursable account;
documenting the incurred expense;
recording documentation of the incurred expense on the computer system;
linking the documentation of the incurred expense to the incurred expense on the computer system;
submitting the documented incurred expense for reimbursement; and
providing reimbursement for the incurred expense based on the recorded expense and the linked documentation.

2. The method of claim 1 further comprising the step of budgeting expenses and accounts.

3. The method of claim 2 further comprising adjusting budgeted expenses and accounts based on at least one of:
the incurred expenses that have not yet been recorded;
the incurred expenses that have been recorded but do not yet have linked documentation;
the incurred expenses with linked documentation;
the incurred expenses which have been submitted for reimbursement; and
the incurred expenses which have been reimbursed.

4. The method of claim 1 wherein the step of allocating the incurred expense to an account corresponding to a reimbursable account occurs automatically.

5. The method of claim 1 wherein the steps of allocating the incurred expense to an account corresponding to a reimbursable account, documenting the incurred expense, and linking the documentation of the incurred expense to the incurred expense occur automatically.

6. The method of claim 1 wherein the step of allocating the incurred expense to an account corresponding to a reimbursable account occurs manually by at least one of:
entry on a portable computing device;
a voice entry;
a manual entry in an expense log.

7. The method of claim 1 wherein the step of recording the incurred expense on the computer system occurs substantially simultaneously with the step of incurring the expense.

8. The method of claim 1 wherein the steps of recording the incurred expense on the computer system, documenting the incurred expense, and linking the documentation of the incurred expense to the incurred expense occur substantially simultaneously with the step of incurring the expense.

9. The method of claim 1 wherein the steps of recording the incurred expense on the computer system, documenting the incurred expense, linking the documentation of the incurred expense to the incurred expense, and submitting the documented incurred expense for reimbursement occur substantially simultaneously with the step of incurring the expense.

10. The method of claim 1 wherein the step of documenting the incurred expense comprises at least one of:
automatic documentation of planned incurred expenses;
scanning a receipt of the incurred expense;
photographing a receipt of the incurred expense;
a voice entry documenting the incurred expense;
keeping a paper copy of the incurred expense; and
an electronic receipt of the incurred expense.

11. The method of claim 1 wherein the method is implemented on a portable computing device.

12. The method of claim 1 wherein the method is implemented on an interactive website accessible over the Internet.

13. The method of claim 1 wherein the incurred expenses are business expenses to be allocated to a particular business account.

14. The method of claim 1 wherein the incurred expenses are expenses to be reimbursed from at least one of:
a flexible heath care account; and
a flexible child care spending account.

15. The method of claim 1 wherein the method is integrated with a conventional financial software module.

16. The method of claim 15 wherein the step of allocating the incurred expense to an account corresponding to the reimbursable account only occurs if the expense is a reimbursable expense and further comprising the steps of:
discriminating between reimbursable expenses and non-reimbursable expenses; and
allocating non-reimbursable incurred expenses to an account corresponding to a non-reimbursable account.

17. The method of claim 16 wherein the account corresponding to the reimbursable account and the account corresponding to the non-reimbursable account are virtual accounts.

18. A method for managing financial resources in an automated fashion comprising:
establishing a plurality of virtual financial accounts, wherein the virtual financial accounts include direct transaction accounts corresponding to personal expenses and reimbursement accounts corresponding to reimbursable expenses;
budgeting and allocating a given amount of funding for each of the direct transaction accounts;
budgeting and allocating a given amount of funding for each of the reimbursement accounts;
incurring an expense;
recording the expense;
documenting the incurred expense;
linking the documentation of the incurred expense and the recorded expense;
allocating the expense to one of the direct transaction accounts if the expense is a personal expense and to one of the reimbursement accounts if it is a reimbursable expense;
updating the budgeted and allocated amount of the account to which the expense is allocated according to the allocated expense;
submitting the documented incurred expense for reimbursement if the documented incurred expense is a reimbursable expense; and
providing reimbursement for the incurred expense based on the recorded expense and the linked documentation if the expense is a reimbursable expense.

19. The method of claim 18 wherein the method is implemented on a computer system selected from the group of a portable computer system, a home computer system, a server, a smart phone, a PDA, and a cell phone.

20. The method of claim 18 wherein the method is implemented on a website accessible from any Internet-connected computer.
